(19) United States
(12) Patent Application Publication
(10) Pub. No.: US 2010/0058205 A1
(43) Pub. Date: Mar. 4, 2010

(54) RECONFIGURABLE MULTIPLE-SCREEN DISPLAY

(75) Inventors: Faramak Vakil, Long Grove, IL (US); Mehran Bagheri, Lake Forest, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/204,549

(22) Filed: Sep. 4, 2008

(51) Int. Cl. G06F 3/00

(52) U.S. Cl. 715/761

(57) ABSTRACT

A device comprises a display arrangement which includes a plurality of displays that are movable relative to each other such that a plurality of display configurations can be achieved. Each of the display configurations provides a combined display area which is different for at least two of the display configurations. An application processor is operable to execute a plurality of user applications, each of which can provide a display output. A display driver is arranged to generate an arrangement of display output for the display arrangement from the display output of an application being executed. The display driver sets a display characteristic for the arrangement of display output in response to a characteristic of the executed application and the deployed display configuration. For example, depending on the application being executed and the current display configuration, a size of a display window used for the application can be selected.

### FIELD OF THE INVENTION

The invention relates to display screens and in particular, but not exclusively, to a communication device such as a mobile phone or a mobile internet device having multiple display screens.

### BACKGROUND OF THE INVENTION

Various electronic user devices have become increasingly popular over the last decade. In particular, portable or mobile devices supporting a range of applications such as mobile phones, Mobile Portable Players, Ultra-Mobile PCs, and other Mobile Internet Devices have become almost ubiquitous.

However, typical portable devices tend to be relatively inflexible and tend to provide a suboptimal user experience which is often limited by the physical dimensions and restrictions of the device. For example, watching a video, reading text, or entering text on a typical user device tends to be an awkward experience as the displays and key pads tend to be too small to support a pleasant overall user experience.

Furthermore, as the devices are increasingly used with different services and applications, the desires and preferences of the user may tend to vary depending on the specific use of the device. For example, the display preferences for a mobile phone are completely different when this is used for watching a video sequence or photo from when it is used for voice communication or for inputting text.

In order to overcome the display size restrictions incurred by a desire to maintain a small size of the device, it has been proposed that a plurality of displays may be used which can be moved between a non-use configuration and a use configuration. In the use configuration the displays may be placed next to each other to form a larger combined display area. However, in the non-use configuration, the displays may be rearranged for a more compact arrangement thereby providing a smaller overall size of the display.

However, such proposals still tend to be suboptimal and in particular they tend to provide a low degree of flexibility and user satisfaction for all use scenarios. They furthermore tend to reduce compatibility and complicate the design of applications.

Accordingly an improved approach would be advantageous, and in particular an approach allowing increased flexibility, increased compatibility and adaptation for multiple applications, an improved user experience, suitability for mobile devices, facilitated implementation or design, and improved performance and operation would be advantageous.

### BRIEF SUMMARY

A device comprises a display arrangement which includes a plurality of displays that are movable relative to each other such that a plurality of display configurations can be achieved. Each of the display configurations provides a combined display area which is different for at least two of the display configurations. An application processor is operable to execute a plurality of user applications, each of which can provide a display output. A display driver is arranged to generate an arrangement of display output for the display arrangement from the display output of an application being executed. The display driver sets a display characteristic for the arrangement of display output in response to a characteristic of the executed application and the deployed display configuration. For example, depending on the application being executed and the current display configuration, a size of a display window used for the application can be selected. The invention may for example provide an improved user experience.

### BRIEF DESCRIPTION OF THE SEVERAL VIEWS OF THE DRAWINGS

Embodiments of the invention are described, by way of example only, with reference to the drawings, in which:

FIG. 1 is an illustration of examples of display configurations for a device in accordance with some embodiments of the invention;

FIG. 2 is an illustration of elements of a device in accordance with some embodiments of the invention;

FIG. 3 illustrates a specific example of a display output for a device in accordance with some embodiments of the invention;

FIG. 4 illustrates a specific example of a display output for a device in accordance with some embodiments of the invention;

FIG. 5 is an illustration of elements of a communication system comprising a device in accordance with some embodiments of the invention; and

FIG. 6 is an illustration of a method of operation for a device in accordance with some embodiments of the invention.

### DETAILED DESCRIPTION

The following description focuses on embodiments of the invention applicable to a communication device such as a mobile phone or a Mobile Internet Device. However, it will be appreciated that the invention is not limited to this application but may be applied to many other devices and applications.

In the following, an example of a device in accordance with some embodiments of the invention will be described. The device includes a display arrangement which comprises a plurality of displays that are movable relative to each other. The displays may be moved such that the display arrangement can be used in different display configurations. In at least one of the display configurations a combined display area is provided by combining the display areas of at least two displays. Specifically, in some display configurations two or more displays may be positioned next to each other to provide a total display area which is the combination of the display areas of the two or more displays. An image which is displayed by the device may in this example be spread over at least two displays.

For example, a first display configuration may correspond to an operational configuration wherein only one of the displays is used in a suitable viewable configuration. Thus, the total display area for the display arrangement in this configuration corresponds to the display area of one of the displays.

The displays may then be moved relative to each other such that they are arranged in a second configuration corresponding to a second display configuration. The second display configuration may for example position two of the displays in a suitable viewing configuration for a user. E.g., two of the displays may be located next to each other. In this display configuration a combined display area of the display arrangement may thus be provided by combining the display areas of the two displays. Thus, an effective display area of the second configuration is twice that of the first display configuration (provided the displays have substantially identical sizes).

It may furthermore be possible to move the displays relative to each other such that they are arranged in a third configuration corresponding to a third display configuration. The third display configuration may for example position four displays in a suitable viewing configuration for a user. E.g., four displays may be located next to each other. In this display configuration a combined display area of the display arrangement may thus be provided by combining the display areas of four displays. Thus, an effective display area of the third configuration is twice that of the second display configuration and four times that of the first display configuration (again provided the displays have substantially identical sizes).

Thus, the device has a very flexible arrangement wherein different display configurations can be used dependent on the current use of the application and the specific preferences and requirements of the user. For example, when traveling on a public transport such as a train or bus, the user may watch a video using the device in a compact configuration wherein only a single display is used. However, when at home the user may unfold the displays to provide a combined effective display made up of, e.g., four displays positioned next to each other. Thus, when at home, an improved video experience may be provided to the user while at the same time allowing the device to be used in a very compact configuration in other contexts.

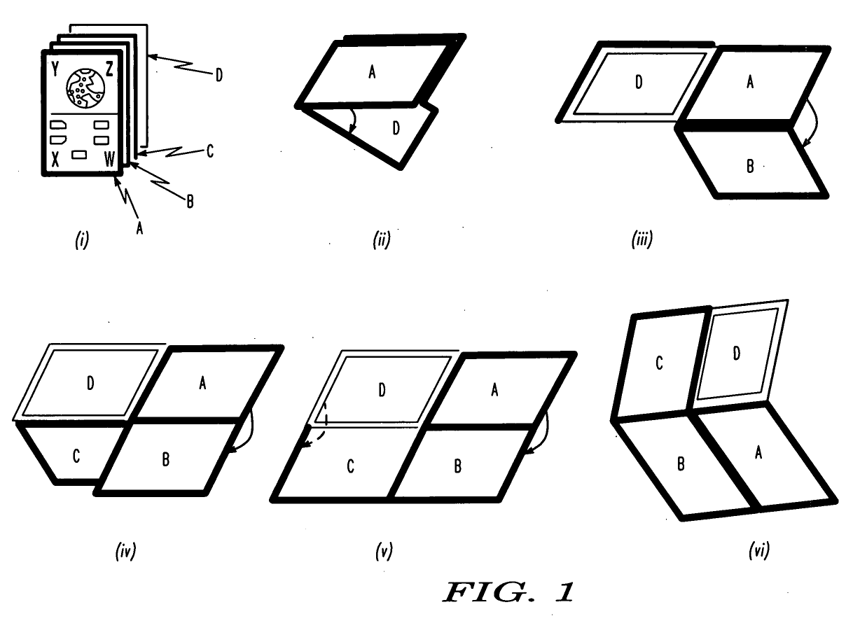

FIG. 1 illustrates a specific example of a quad display multimedia device which specifically may be a mobile phone or a Mobile Internet Device. The device has a display arrangement in the form of a foldable deck of ultra-thin displays.

In the example, four displays A-D are rotatably attached to each other. Specifically, each display is rotatably attached to at least one other display along one edge such that the two attached displays can rotate around this edge. Thus, in the example, a first display A is rotatably attached to a second display D along an edge of the first display A and the second display D. Thus, the two displays A, D can be rotated relative to each other around the rotation axis corresponding to the edges of the displays. The rotatable attachment may for example be achieved using a suitable hinge mechanism.

Furthermore, a third display B is rotatably attached to the first display A along another edge of the first display and along an edge of the third display B. In the example, the displays are substantially rectangular displays, and the two edges of the first display A which are attached to other displays B, D are adjacent edges of the first display A. Thus, in the example, the angle between the two edges of the first display A which are attached to other displays B, D is at an angle of substantially 90° relative to each other (e.g., within ±5°).

Thus, the third display B can be rotated relative to the first display such that it takes up a position next to the first display A and without interfering with the second display D.

In addition, a fourth display C is rotatably attached to the second display D along another edge of the second display D and along an edge of the fourth display C. In the example, the two edges of the second display D which are attached to other displays A, C are adjacent edges and an angle between the two edges is at substantially 90° (e.g., within ±5°).

Thus, the fourth display C can be rotated relative to the second display D such that it takes up a position next to the second display D and without interfering with the second display D or the first display A. Furthermore, the fourth display C may be positioned next to the third display B. Indeed, by rotating the displays relative to each other, the four displays A-D may be positioned next to each other, two of the displays A, D may be positioned next to each other, or the displays may be folded up to take up the space of only a single display. Thus, by a simple rotation of the displays, three different display configurations can be achieved with each configuration having a different combined display area.

In the specific example, at least two of the displays are furthermore touch-sensitive displays that can be used to provide a user input. Thus, the display arrangement can furthermore be used as, e.g., a keypad.

FIG. 1 illustrates the specific exemplary device in a compact configuration (i), the unfolding of this to the maximum display area configuration (iv), and the use in two different configurations, namely as a single display, e.g., for watching video or reading text (v) and as a combined display and keypad, e.g., for displaying and entering text (vi.).

In the example, a whole surface side of the device is in the compact configuration (i) made up of one display thereby maximizing the display area for a given size. In the example, display D is attached to display A only at edge YZ and can rotate around this edge at least 270 degrees clockwise (ii). Display B is attached to display A only at edge XY and can rotate around this edge at least 180 degrees clockwise (iii). Display C attaches only to display D at one edge of D and such that display C can rotate around this edge at least 180 degrees clockwise (iv). After unfolding the device fully, the four displays may provide a single integrated display area, e.g., for presenting a video signal (v). Alternatively, the displays may be used to provide both a display and a touch screen keypad (vi). It will be appreciated that other functions may also be possible. For example, a medium sized display may be provided by unfolding the device only around the rotatable attachment between displays A and D thereby providing a combined display made up of displays A and D only.

In the example, the four displays have substantially the same size (e.g., less than 5% difference) and specifically the same dimensions (and thus aspect ratio). This may improve the performance of the device and may in particular facilitate the folding design such that both compact configurations and large display area configurations can be achieved. In particular, it may often maximize the difference between the most compact and the largest display area configuration.

In the example, each display furthermore has a display area that substantially covers the entire surface of the display side (e.g., more than 90%). This may facilitate and improve the interworking between the displays and may specifically improve the image quality when display images are overlapping a plurality of the displays.

Also in the example, the combined display area of one of the display configurations corresponds to a display area of one display. Specifically, when in the compact configuration, the total display area is made up by a single display. This may allow a compact configuration while still providing a suitable display area.

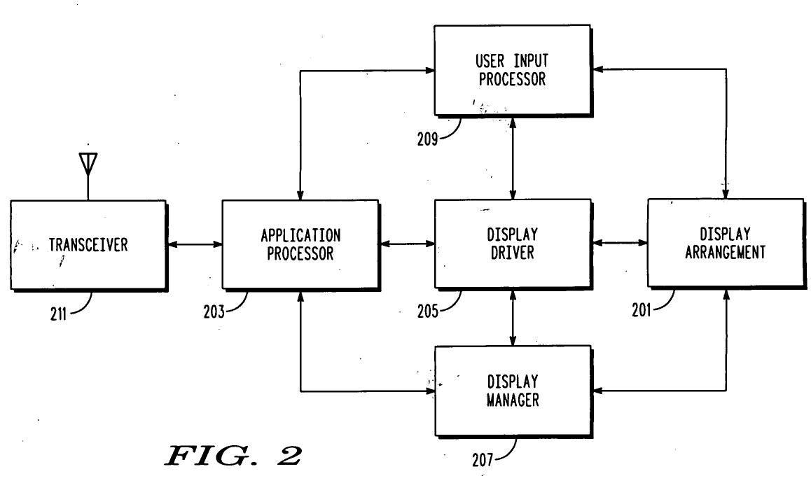

FIG. 2 illustrates an example of elements of a device in accordance with some embodiments of the invention. The device specifically includes a display arrangement 201 which comprises a plurality of displays moveable relative to each other to provide a plurality of display configurations. In the specific example, the device comprises the display arrangement of FIG. 1.

The device of FIG. 2 is furthermore arranged to adapt the use of the display depending on the display configuration and the specific use. In addition, the display output may be adapted to specific user preferences.

Furthermore, in the example, the display arrangement 201 comprises touch-sensitive sensors such that a user input can be generated by the user touching the displays. In the system, the use of the display arrangement 201 is further controlled such that the display usage and allocation for respective user output interface (display) and user interface input (touch-sensitive input) are dynamically controlled depending on the specific application and the deployed display configuration.

Thus, the device may not only provide a flexible display output but may also provide a flexible user interface that can be adapted to the specific current use of the device. Indeed, the approach may allow the device to be dynamically configured to provide very different user interface configurations. For example, the operation of the device may adapt itself to provide, e.g., predominantly a user display, predominantly an input interface, or a suitable combination thereof. Thus, the function and purpose of the display arrangement 201 can dynamically be changed thereby allowing the device to easily and dynamically be transformed from one device type to another. For example, the device may easily be transformed from being a large display video-rendering device to being a more compact micro-computer with a dedicated keyboard for user input.

The device comprises an application processor 203 which is capable of executing a plurality of user applications. For example, the application processor 203 may execute a video display application that presents a video sequence to a user, a text-based communication application (such as texting or email), or a game application, etc. In the example, the application processor 203 is arranged to execute one application at a time. Thus in the example the application processor 203 may either present a video sequence, or execute a text communication application, or execute a game application, etc. However it will be appreciated that in other embodiments the application processor 203 may in some scenarios execute a plurality of applications simultaneously. An example of this will be a scenario where the user is using displays A & D, e.g., for video conferencing, while using displays B & C for text messaging.

The applications executed by the application processor 203 generate a display output which is fed to a display driver 205 coupled to the application processor 203 and to the display arrangement 201. The display driver 205 generates an arrangement of display output for the display arrangement 201 such that the desired image is displayed by the display arrangement 201. The arrangement of display output is generated from the display output of the application being executed by the application processor 203.

It will be appreciated that in many embodiments and implementations, the application processor 203 and the display driver 205 may be closely integrated, and the combined functionality of these may, e.g., be provided by a single process. Specifically, the functionality of the display driver 205 may be implemented as an integral part of the applications executed by the application processor 203.

The display driver 205 is arranged to adapt the display output from the executed application in order to provide a suitable display driver signal (the arrangement of display output) for the display arrangement 201. This arrangement of display output is fed to the display arrangement and results in the appropriate image being generated by the display arrangement 201. For example, for a video application the video signal generated by the application processor 203 may be at a fixed resolution which is then adapted to the specific resolution of the display arrangement 201.

The device also comprises a display manager 207 which is coupled to the application processor 203, the display driver 205, and the display arrangement 201. The display manager 207 is arranged to set a display characteristic for the arrangement of display output in response to a characteristic of the executed application and a deployed display configuration.

Thus, the display manager 207 can modify the processing of the display driver 205 such that an appropriate output is generated by the display arrangement which is specifically targeted to the specific application currently being executed and to the specific display configuration that is currently deployed.

For example, the display manager 207 may be arranged to determine a display characteristic in response to an identification of the application being executed. Thus, the application processor 203 may provide an identification of the application being executed to the display manager 207, and the display manager 207 may select the display characteristic to suit the executed application.

For example, the display characteristic may be a size or shape of the display area of the display arrangement 201 which is used to present the display output of the executed application. The display manager 207 can for example store a set of values for the display characteristic for the different possible applications. For example, it may be predefined that the video application should have a 16:9 aspect ratio and use the full available display area of the display arrangement 201, the text-based communication application should use the full width of the current display configuration but leave a fixed-size display area of the touch-sensitive displays for use as a keypad entry, etc.

The display manager 207 furthermore receives information from the display arrangement 201 which indicates the current display configuration. The display manager 207 then uses this information to set the display characteristic. Specifically, it may set the characteristic such that the maximum display size of the current configuration is fully utilized under the constraints provided for the specific application. Thus, the display manager 207 is in the specific example provided with information that indicates whether the device is used in a configuration where only a single display is used, where two adjacent displays are used, or where all four displays are used. Thus, the display manager 207 identifies whether the maximum available display area corresponds to the display area of one display, of two displays, or of all four displays.

The display manager 207 then determines the appropriate display characteristic, e.g., function, length, height, or area, etc., that suits the specific application and configuration. Specifically, the application executed by the application processor 203 may generate a display output for an image to be displayed by the display arrangement 201. The display characteristic may for example be (or include) a size characteristic of an image section of the available display area which is used for displaying the display output of the executed application. For example, a length, height, shape, or area of a window of the total combined display area may be determined based on the application as well as on the display configuration.

In the device, the total combined display area of at least some of the display configurations is provided by overlapping an image section used for displaying the output of the application between a plurality of the displays. Thus, the degree of overlap may be determined in response to the application and the display configuration.

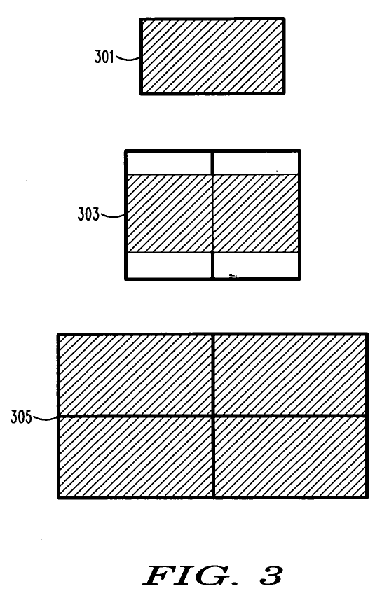

FIG. 3 illustrates a specific example of how the display manager 207 may control the generated output from the executed application. In the specific example, the application processor 203 informs the display manager 207 that the video application is being executed. Accordingly the display output from the application processor 203 fed to the display driver 205 corresponds to a 16:9 aspect ratio video sequence at a given resolution.

The display arrangement 201 furthermore provides information to the display manager 207 indicating what the current display configuration is for the display arrangement 201. Specifically, the display manager 207 is informed of whether the user is using the device in the compact configuration wherein only a single display (A) is used, in semi-unfolded configuration wherein two displays (A+B) are used, or in a fully unfolded configuration wherein all four displays are used.

The display manager 207 then accesses a look-up table defining the desired display output for the display arrangement 201 for the specific combination of the application being executed and the current display configuration.

In the specific example, a policy may be specified for the video application indicating that the aspect ratio should be maintained at 16:9 and that the video should be presented in the largest possible window. Thus, if the device is used in the display configuration wherein only a single display is active and assuming that the display has an aspect ratio of 16:9, the display manager 207 defines the active display area as the entire display area of the single display. This information is fed to the display driver 205 which proceeds to generate an arrangement of display output that has a resolution which corresponds to the pixel resolution of a single display. Thus a video output 301 corresponding to the size of the single display is generated.

However, if the device is used in the display configuration wherein two displays are active, the display manager 207 defines the active display area as the largest 16:9 aspect ratio window of the combined display area. In the specific example, this corresponds to a window which has a length corresponding to twice the height of each display and which overlaps the two displays. This information is fed to the display driver 205 which proceeds to generate an arrangement of display output that has a resolution width twice the resolution height of each display and a resolution height which results in a 16:9 aspect ratio. Furthermore, the display driver 205 centers this window in the display area resulting in the display output 303 of FIG. 3.

If the device is used in the display configuration where all four displays are active, the display manager 207 defines the active display area as the entire display area of all four displays. This information is fed to the display driver 205 which proceeds to generate an arrangement of display output that has a resolution which corresponds to the pixel resolution of the combined image of the four displays. Thus a video output 305 corresponding to the size of the four displays and overlapping all four displays is generated.

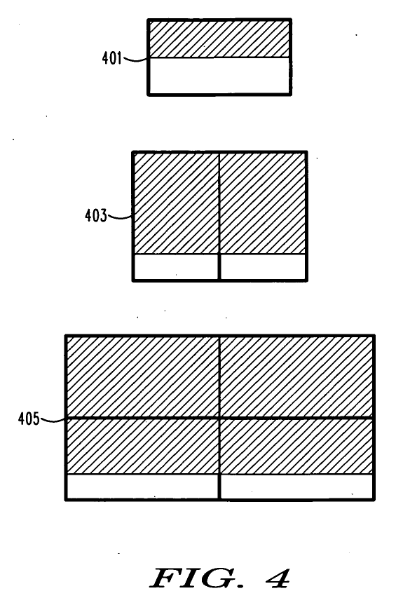

FIG. 4 illustrates an example wherein the application processor 203 executes a text-based communication application. For this application, a rule may be specified that a fixed-height keypad must be implemented using the touch-sensitive display A and that a rectangular-image section or window should be used to display the text. Thus, depending on the display configuration, the display driver may present text in differently sized windows as illustrated by the display windows 401, 403, and 405 of FIG. 4. In the example, the display manager 207 may furthermore provide an indication to the application processor 203 of the display size thereby allowing the executed application to customize the text output to the available display window.

In the specific examples provided above, some relatively simple rules are used to control the display characteristic, but it will be appreciated that in other embodiments substantially more complex and intricate rules and policies may be used to customize and adapt the display output.

It will be appreciated that in different embodiments the rules, policies, and criteria of determining the appropriate display characteristic value may be determined and generated in different ways.

In some embodiments, the device may specifically comprise a user input that allows a user to generate a rule which relates the setting of the display characteristic to a property of the executed application or to a property of the deployed display configuration (or both). For example, the user may specifically specify that a video clip should always be presented in the largest possible display window while retaining the aspect ratio. As another example, the user may specify that the video should always be generated with a specific orientation relative to the display arrangement (i.e., the user may specify a rule that prevents the device needing to be rotated when the display configuration is changed by the user).

It will be appreciated that the rules may be explicitly specified by the user or that the rules may be determined by the device from indirect indications by the user.

In some embodiments, the device may comprise a user preference processor that determines a user display preference in response to a previous user operation of the device. For example, the user preference processor may monitor the use of the device by the user based on context or may particularly monitor the specific selections and modifications manually made by the user.

In response to this user preference, the display manager 207 may generate a rule which relates the setting of the display characteristic to a property of the executed application or to a property of the deployed display configuration (or both). This rule is then used to set the display characteristic for the specific application and display configuration.

As a specific example, the user preference processor can monitor the user's actions for each application. For example, when the video application is executed, the user may be able to dynamically and manually modify the window size or dimensions used to display the video. For example, the user can manually expand or contract the video image presented on the display (for all display configurations). The user preference processor can then monitor the window size that is typically preferred by the user for the different display configurations, and this can be used by the display manager 207 to establish a rule that sets the default windows size generated by the display driver 205 when the video application is executed to the size most often selected by the user.

Thus, in the device of FIG. 2, the display manager 207 can adapt the size, orientation, function, and other display characteristics to the specific scenario in which it is used, as well as to the user's preferences, directions, and contexts. Specifically, a configurable display can be used in a number of different display configurations with the display manager 207 being able to automatically adapt the operation to the specific display configuration and the specific application being used.

The display manager 207 may specifically store a number of rules, requirements, and policies for determining different display properties taking into account the different configurations and modalities of the display arrangement 201. Furthermore, in many embodiments the dynamic and flexible adaptation can be achieved without requiring modification of the individual application or requiring that the application considers or adapts to the specific display configuration. Indeed, in many scenarios the flexible display adaptation can be achieved while using standard applications that are designed for a single fixed-size display.

In some embodiments, at least one section of one display is a touch-sensitive display which is capable of receiving a user input. For example, one of the displays (say display A) may be a touch-sensitive display which, e.g., can be used to receive user selections by the user pressing an appropriate area of the screen. This may be used by the application, for example by this section being used to generate a keyboard for text entry.

In such embodiments, the display characteristic being adapted by the display manager 207 may comprise a size characteristic for the area of the touch-sensitive section which is being allocated to receive user inputs or a size characteristic for an area of the touch-sensitive section which is allocated to display the display output from the application (or both).

Specifically, dependent on the specific application or the display configuration (or both), the area of the touch-sensitive section which is used to provide a display output and to receive user inputs may be dynamically selected by the display manager 207.

For example, in the example of FIG. 3, the entire touch-sensitive area of display A is used to display the video sequence (at least for the compact and completely unfolded configurations). However, for the text communication application, approximately half of the touch-sensitive display area of display A is allocated to display the text communication, and the other half is allocated to the provision of a keyboard that can be used for text entry to the application.

In the example of FIG. 2, the device comprises a user-input processor 209 which is coupled to the display arrangement 201, the display driver 205, and the application processor 203. The user-input processor 209 is capable of managing the use of the touch-sensitive display and specifically is capable of controlling the image that is displayed on the section of the display arrangement 201 which is allocated to the touch-sensitive input.

For example, if the application processor 203 executes a text communication application, part of the display arrangement 201 should be allocated to provide a keyboard allowing the user to enter text. Accordingly, the display manager 207 detects that this application is initialized, and based on the configuration of the display arrangement 201 it proceeds to identify an image section of the display arrangement 201 that should be used for displaying the display output of the application as well as an input image section that should be used for the keyboard input. This information is fed to the display driver 205 and (e.g., via the display driver 205) to the user-input processor 209.

The user-input processor 209 then proceeds to generate an image for the input image section which corresponds to a keyboard (e.g., with a plurality of square boxes each of which corresponds to a number or letter). This image is fed to the display arrangement 201 such that it is displayed in the input image section.

The user-input processor 209 furthermore receives touch-sensitive signals that are generated by the display arrangement 201 detecting a touch. It then proceeds to evaluate these touch signals to determine which keys have been pressed. In response, it generates a text output which is fed to the application processor 203 to be used as an input to the text communication application.

Thus, in this example, the application can simply generate a display output without considering the specific display configuration and can base the operation on a simple text input. The control functionality of the device can then automatically adapt the operation to the specific application and the display configuration such that an effective user interface providing both for user output and user input is achieved.

Furthermore, the device can flexibly and dynamically adapt the user interface to suit the specific application and display configuration. Indeed, the approach may allow the entire user interaction of the device to be dynamically adapted to provide the specific user interface and user experience suitable for the specific application and context. Indeed, to the user the device may provide the same functionality and experience as for multiple devices specifically designed for specific applications. For example, the device may provide user interfaces and interactions that can be dynamically adapted to, e.g., a video rendering application having only a display output, a micro-computer having both a display output and a keyboard, etc.

As a specific usage example for the device of FIG. 2, the user may select the video application in order to watch a broadcast football game. The user may unfold the device into the fully unfolded configuration (corresponding to configuration (v) of FIG. 1). The display manager 207 receives information identifying that the video application is used with this display configuration, and in response the display manager 207 retrieves the corresponding display policy or rule. In the example, this may specifically state that the entire display arrangement 201 should be used to show the video sequence and that the received video pixels shall be divided into four spatial subsets corresponding to the four displays such that each quarter video frame will be correctly displayed by one of the four displays. Thus, the display driver 205 is controlled to divide the received video stream into four sub-streams, each of which is fed to one of the displays.

If the user selects another application corresponding, e.g., to a general computational device (e.g., a mini-computer or a Mobile Internet Device), the device manager 207 may retrieve the corresponding policy or rule. This may, e.g., state that displays A and B should be used as a keyboard for character entry (assuming both of these displays are touch sensitive) and that displays C and D should be used for the display output of the computational device application. The user may in this case specifically use the device in configuration (vi) of FIG. 1. In response, the display driver 205 will proceed to generate a display output covering displays C and D, and the user-input processor 209 will proceed to generate a keyboard image for displays A and B and to detect the touch signals and convert these into text data that are fed to the application processor.

In the specific example, the device of FIG. 2 is a communication device which is capable of receiving a data stream from a remote server. Specifically, the device is a mobile phone or a Mobile Internet Device which comprises a transceiver 211 capable of receiving a data stream over an air interface of the suitable communication system, which, e.g., may be a wireless network (e.g., WiFi™) or a cellular communication system (such as, e.g., GSM or UMTS). The data stream may for example be a real-time video stream which is fed to the application processor 203. The video stream may be processed by the video application to generate a display output for presenting the video on the display arrangement 201.

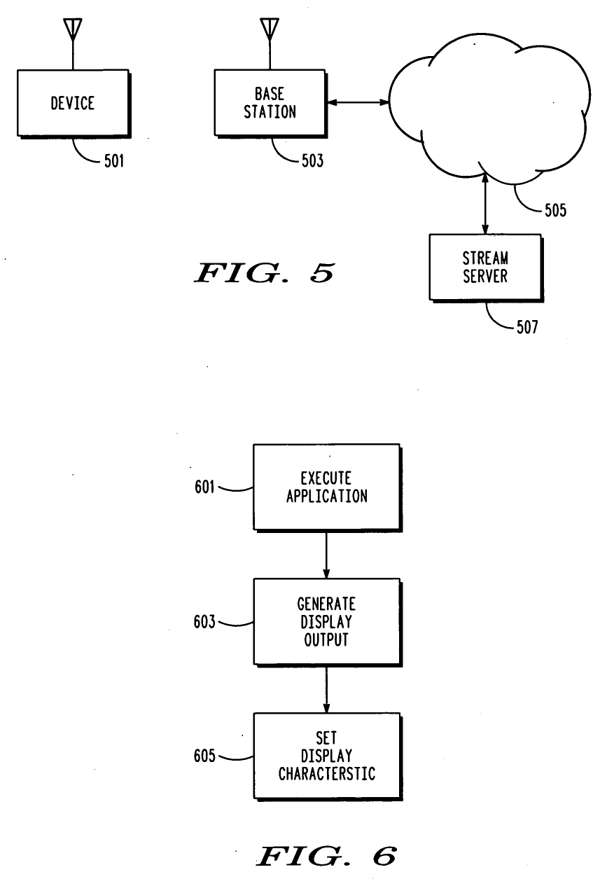

FIG. 5 illustrates a simplified example of such a communication system. The device 501 of FIG. 2 communicates with the base station 503 over an air interface of the communication system. The base station 503 is coupled to a communication network 505 which is furthermore coupled to a stream server 507. In the example, the video application may communicate with the stream server 507 via the base station 503 and the communication network 505 to request that a specific video is streamed to the device 501. The transmitted video stream is then received by the transceiver 211 which feeds it to the video application.

In the example, the video application thus generates a display output from the received video data stream. The display output is then fed to the display driver 205.

In the example, the display manager 207 is arranged to set the display characteristic in response to a characteristic of the received data stream. Specifically, the display characteristic may be set in response to a video quality characteristic for the received video data stream.

For example, different video streams may have different characteristics. For example, some video streams provided by the stream server 507 may be at one resolution, whereas other video streams may be at other resolutions. In this case, the display manager 207 may set the display area that is used for presenting the video sequence depending on the resolution of the received video stream. For example, for a very low resolution it will not be advantageous to use the entire display area of the completely unfolded display configuration as this will merely show the low quality of the received video stream. Therefore, the display manager 207 may set the display area used for presenting the video stream such that a suitable user experience is provided. Specifically, the display manager 207 may set a maximum display area as a function of the resolution of the received video stream.

As another example, the data rate of the received video stream may be used to set the display area. For example, at low data rates, a high degree of compression will typically be used resulting in a relatively low video quality. Accordingly, a smaller display area may be used by the display manager 207 in order to provide a reasonable perceived video quality albeit for a smaller image.

The characteristic of the received video stream is not necessarily a characteristic that has been set by the stream server 507 but may alternatively or additionally be a characteristic which depends on the actual communication of the video stream. For example, it may depend on a characteristic of the air interface communication, such as a bit error rate.

The device 501 may thus automatically adapt the use of the configurable display arrangement 201 such that it matches the specific conditions experienced. As a specific example, a user may like to watch a live broadcast of a soccer game when waiting in an airport. However, the live broadcast may not be available via the user's usual video service but may possibly be available via a dedicated video service provided at the airport. However, the video of this service may be presented in a lower resolution than used by the user's normal video service. In this situation, the display manager 207 may automatically adapt the displayed video sequence to the specific characteristics.

In some embodiments, the device 501 may be capable of communicating with the stream server 507 in order to control a characteristic of the transmitted data stream (and specifically of the video stream). In particular, depending on the currently used display configuration, the device 501 may transmit a request to the stream server 507 requesting that a characteristic of the generated data stream be adapted to the specific configuration.

For example, as a default the stream server 507 may generate a video stream which has a resolution corresponding to the combined resolution of the four displays (i.e., four times the resolution of a single display). When using the video application with a display configuration corresponding to the display being completely unfolded, the video data stream may thus be used directly without any resolution modification.

If the display arrangement 201 is changed to the display configuration corresponding to only a single display being used (configuration i of FIG. 1), the display manager 207 may control the display driver 205 to reduce the resolution by a factor of four such that the arrangement of display output is suitable for a single display. However, this will result in an unnecessary resource usage for the communication of the video stream as a much higher data rate is communicated than what is necessary. Accordingly the device 501 may generate a request that the video resolution of the video stream be reduced by a factor of four before being transmitted by the stream server 507. In response to receiving the request, the stream server 507 may reduce the resolution as requested thereby providing a substantial reduction in the required communication bandwidth. If the display configuration is then changed back to the fully deployed configuration, the device 501 may send another request for the resolution of the video stream to be changed back to the original resolution.

It will be appreciated that other factors of the data stream may be changed in response to requests from the device 501.

For example, a content quality level of the data stream may be changed. Specifically, the video quality for the video stream may be changed in response to the stream server 507 receiving a request from the device 501. The video quality may for example be changed by changing the degree of compression applied when encoding the video signal. For example, the stream server 507 may store different versions of the same video sequence encoded using different encoding schemes with different compression levels. When the device 501 is used with a display configuration having a small display area, quality degradation is less perceptible, and accordingly a high degree of compression may be used. When the display configuration is changed to one providing a larger display area, quality degradations (such as coding artifacts) become more perceptible, and accordingly the video stream may be switched to a version of the video sequence encoded with less compression.

As another example, the data rate of the data stream may be modified in response to requests from the device 501. The data rate may for example be changed by changing the encoding or compression for the data stream as described in the previous paragraph.

As yet another example, a communication quality level of the data stream may be changed in response to a request from the device 501. For example, quality degradations caused by data errors in the data stream are more significant when a larger display area is used than for smaller display area. Accordingly, if the user moves the displays into the compact display configuration (i of FIG. 1), the device 501 may request that the stream server 507 switch to a communication service that has a lower quality of service requirement. Specifically, the device 501 can request that the stream server 507 switch to a location service that allows a higher number of bit errors for the air interface communication between the base station 503 and the device 501. This will typically reduce the resource requirement and cost of the service.

It will be appreciated that the requests generated by the device 501 need not be generated in response to user interactions or requests and indeed may be performed completely without the user's knowledge. Specifically, the video application or the display manager 207 may automatically evaluate the current display configuration and transmit suitable requests. Thus, the stream server 507 (and thus an operator of the video service) may automatically adapt characteristics of the provided data stream to the specific use of the device 501 without the user being aware of this adaptation.

In the previous examples the display arrangement 201 comprises a plurality of different displays that can be manually moved by a user. However, in some embodiments, the movement of the displays relative to each other may be performed automatically. Thus, the display arrangement may comprise one or more actuators arranged to cause a physical movement of one of the displays relative to another. For example, a stepper motor may be included for each rotational attachment, thereby allowing the display arrangement to be automatically changed from one display configuration to another.

In some such embodiments, the actuators can be controlled remotely. For example the actuators may be controlled by the stream server 507. This may provide an enhanced user experience in many environments. For example, the device 501 may be attached to a suitable static mount. For example, the device may be attached to a fixed wall mount. The stream server 507 may then send a control signal to the device 501 that will cause the display configuration to be changed. For example, immediately prior to transmitting a video sequence, a control signal may be sent that causes the device 501 to move the displays into the fully unfolded display configuration. The video sequence may then be presented using the maximum available display area. When the video sequence finishes the stream server 507 may control the device 501 to move the displays back to the compact configuration.

Such an example may be useful for devices used for occasional public information (e.g., for traffic updates, etc).

In some embodiments, the actuators may be automatically controlled in response to a characteristic of the received data stream. For example, depending on the resolution of the received video stream the display manager 207 may decide whether to use a display area corresponding to a single display, a window overlapping two displays, or a window corresponding to all four displays. Furthermore the display manager 207 may control the actuators to move the displays into the display configuration that matches the specific display area mode selected. E.g., for a high video resolution the displays may be moved into the fully unfolded configuration, and for a low video resolution the actuators may move the displays into the compact configuration.

FIG. 6 illustrates a method of operation for a device in accordance with some embodiments of the invention.

The device includes a display arrangement comprising a plurality of displays movable relative to each other to provide a plurality of different display configurations where each display configuration provides a combined display area and with the combined display area for at least some of the display configurations being different.

The method initiates in step 601 wherein a first application of a plurality of user applications providing display output is executed.

Step 601 is followed by step 603 wherein an arrangement of display output for the display arrangement is generated from the display output of the first application.

Step 603 is followed by step 605 wherein a display characteristic for the arrangement of display output is set in response to a characteristic of the first application and a deployed display configuration.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware, or any combination of these. The invention may optionally be implemented at least partly as computer software running on one or more data processors or digital signal processors. The elements and components of an embodiment of the invention may be physically, functionally, and logically implemented in any suitable way. Indeed the functionality may be implemented in a single unit, in a plurality of units, or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, or method steps may be implemented by, e.g., a single unit or processor. Additionally, although individual features may be included in different claims, these may possibly be advantageously combined, and the inclusion in different claims does not imply that a combination of features is not feasible or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked, and in particular the order of individual steps in a method claim does not imply that the steps must be performed in this order. Rather, the steps may be performed in any suitable order.

We claim:

1. A device comprising:
a display arrangement (201) comprising a plurality of displays movable relative to each other to provide a plurality of display configurations, each display configuration providing a combined display area, and the combined display area for at least some of the display configurations being different;
an application processor (203) operable to execute a plurality of user applications providing display outputs;
a display driver (205) arranged to generate an arrangement of display output for the display arrangement from a display output of a first application of the plurality of user applications being executed; and
a display manager (207) arranged to set a display characteristic for the arrangement of display output in response to a deployed display configuration and a characteristic of the first application.

2. The device of claim 1 wherein the characteristic of the first application comprises an identification of the first application.

3. The device of claim 1 wherein the display manager (207) is arranged to set the display characteristic in response to a maximum display size for the deployed display configuration.

4. The device of claim 1 wherein the display characteristic comprises a size characteristic of an image section of a display area of the deployed display configuration being used for displaying the display output of the first application.

5. The device of claim 1 wherein the display characteristic comprises an overlap characteristic of an image section of a display area of the deployed display configuration being used for displaying the display output of the first application, the overlap characteristic being indicative of an overlap of the image section among the plurality of displays.

6. The device of claim 1 wherein the display manager (207) is arranged to generate a rule relating a display characteristic setting and a characteristic of at least one of a property of the first application and a property of the deployed display configuration in response to a user input, and to determine the display characteristic in response to the rule.

7. The device of claim 1 further comprising a user preference processor arranged to determine a user display preference in response to a previous user operation of the device;
wherein the display manager (207) is arranged to generate a rule relating a display characteristic setting and a characteristic of at least one of a property of the first application and a property of the deployed display configuration in response to the user display preference, and to determine the display characteristic in response to the rule.

8. The device of claim 1 wherein at least a section of at least one display of the plurality of displays is a touch-sensitive display capable of receiving a user input; and wherein the display characteristic comprises a size characteristic for an area of the section allocated to receive user inputs and a size characteristic for an area of the section allocated to display at least part of the display output of the first application.

9. The device of claim 8 further comprising a user-input processor (209) for generating a user input display image for the area of the section allocated to receive user inputs; and means for generating a user input for the first application in response to a touch input detected in the area of the section allocated to receive user inputs.

10. The device of claim 1 wherein the first application is arranged to generate the display output in response to a received data stream; and the display manager (207) is arranged to set the display characteristic in response to a characteristic of the received data stream.

11. The device of claim 10 wherein the received data stream is a video data stream, and wherein the characteristic of the received data stream comprises a video quality characteristic for the video data stream.

12. The device of claim 1 wherein the first application is arranged to generate the display output in response to a data stream received from a remote source; and the device is further arranged to request the remote source to set a characteristic of the data stream in response to a characteristic of the deployed display configuration.

13. The device of claim 12 wherein the characteristic of the data stream comprises at least one characteristic selected from the group consisting of:
a data rate of the data stream,
a communication quality level of the data stream,
a content quality level of the data stream, and
a resolution of the data stream.

14. The device of claim 1 further comprising at least one actuator for moving at least one display of the plurality of displays relative to at least one other display of the plurality of displays to reach a display configuration in response to a characteristic of a received data stream processed by the first application.

15. The device of claim 1 further comprising:
a receiver (211) for receiving a display control signal from a remote source; and
at least one actuator for moving at least one display of the plurality of displays relative to at least one other display of the plurality of displays to reach a display configuration in response to the display control signal.

16. The device of claim 1 wherein a first display of the plurality of displays is rotatably attached to a second display of the plurality of displays along a first edge of the first display and a first edge of the second display;
wherein a third display of the plurality of displays is rotatably attached to the first display along a second edge of the first display and along a first edge of the third display; and
wherein a fourth display of the plurality of displays is rotatably attached to the second display along a second edge of the second display and along a first edge of the fourth display.

17. The device of claim 16 wherein the first edge of the first display is at an angle of substantially 90° relative to the second edge of the first display; and
wherein the first edge of the second display is at an angle of substantially 90° relative to the second edge of the second display.

18. The device of claim 16 wherein the first display, the second display, the third display, and the fourth display have substantially identical sizes.

19. The device of claim 1 wherein a combined display area for one of the display configurations corresponds to a display area of one display of the plurality of displays.

20. A method of operation for a device including a display arrangement (201) comprising a plurality of displays movable relative to each other to provide a plurality of display configurations, each display configuration providing a combined display area, and the combined display area for at least some of the display configurations being different, the method comprising:
an application processor (203) executing a first application of a plurality of user applications providing display outputs;
generating an arrangement of display output for the display arrangement from the display output of the first application; and
setting a display characteristic for the arrangement of display output in response to a deployed display configuration and a characteristic of the first application.
